(19) United States
(12) Patent Application Publication
(10) Pub. No.: US 2005/0115995 A1
(43) Pub. Date: Jun. 2, 2005

(54) UTILITY CARRIER

(75) Inventor: Doyle Wayne DeWoody, Sarasota, FL (US)

Correspondence Address: Doyle Wayne DeWoody, 5276 Willow Links, Sarasota, FL, 34235, US

(73) Assignee: Mr. Doyle Wayne DeWoody, Sarasota, FL (US)

(21) Appl. No.: 10/904,768

(22) Filed: Nov. 27, 2004

Related U.S. Application Data
(60) Provisional application No. 60/525,334, filed on Nov. 28, 2003.

(51) Int. Cl. B60G 9/02; B60R 9/00; B60P 1/00; B62D 1/00

(52) U.S. Cl. 224/42.11; 224/42.32

(57) ABSTRACT

A utility carrier for carrying objects above the roof of a vehicle has a frame that supports cargo, or supports devices to secure cargo to the carrier. The carrier consists of a tower, mounted either to the body side, side frame of the vehicle, or to the bed of a pickup-type truck, that supports a cantilevered beam forming a base for the intended cargo, so that the weight of the carrier and the cargo is distributed to the tower assemblies, and through them to the vehicle attachment points. The carrier is attached to the vehicle only through the tower/beam assembly, or through a pair of the assemblies, and does not restrict the operation of a convertible top or the installation/removal of a hard top. The utility carrier is located on the vehicle in such a manner that vehicle operator's visibility is not impaired, and none of the vehicle's exterior lights, including taillights, are blocked.

### 1. FIELD OF THE INVENTION

The present invention relates to carriers that are configured to be attached to motor vehicles for carrying objects such as bicycles, skis, boats, surfboards and the like, and more particularly is directed towards the means of attachment to the vehicle and the structural method of supporting the weight of the object(s) borne by the carrier.

### 2. DESCRIPTION OF THE PRIOR ART

Vehicle carriers of this type are typically attached to the rooftop, a receiver hitch assembly, a roll bar assembly, the rear bumper, or to the vehicle frame in three, four, or more attachment points. These carriers are well known, and the following patents describe the various types of these devices:
U.S. Pat. No. 2,492,841 to Burkey, Dec. 27, 1949
U.S. Pat. No. 2,643,040 to Hare, Jun. 23, 1953
U.S. Pat. No. 2,779,524 to Carlson, Jan. 29, 1957
U.S. Pat. No. 3,260,929 to Hedgepeth, Jul. 12, 1963
U.S. Pat. No. 4,538,752 to Welter, Sep. 3, 1985

These inventions have met with varying degrees of success. The increase in popularity of outdoor recreational activities requiring the vehicular transport of bicycles, kayaks, canoes, etc., coupled with the increasing popularity of small trucks and sport utility vehicles, has created a need for a more versatile, aesthetic, and useful carrier. This invention provides attachment and multi-use advantages not available in prior devices.

### SUMMARY OF THE INVENTION

The present invention utilizes a tower supporting a cantilevered beam to provide a stable platform for carrying objects above the roof of a motor vehicle, and can be used in pairs, one tower on each side of the vehicle, for greater load-carrying capacity and aesthetics. The base tower(s) attach to either the side(s) of the motor vehicle, or to the vehicle frame(s) of the vehicle, or to the bed of small trucks, and extend upward to a cantilevered beam above the roof of the vehicle and parallel to the side of the vehicle. The tower/beam assembly, alone or in conjunction with a tower/beam assembly mounted on the opposite side of the vehicle, provides a means to support cargo of varying shapes, dimensions, and design attributes.

Other objects of the present invention will in part be obvious and will in part appear herinafter.

The present invention does not impinge upon the vehicle operator's visibility, or the visibility of any of the exterior lights, including taillights, of the vehicle.

An important object of the invention is to provide a cargo support frame that can be used on convertible vehicles, or vehicles with removable tops. The tower/beam assemblies do not have to be removed from the vehicle in order to operate or to install/remove the top.

The invention accordingly comprises the apparatuses and systems, together with their parts, elements and interrelationships that are exemplified in the following disclosure, the scope of which will be indicated in the appended claims.

### BRIEF DESCRIPTION OF THE DRAWINGS

A fuller understanding of the nature and objects of the present invention will become apparent upon consideration of the following detailed description taken in connection with the accompanying drawings, wherein:

FIG. 1 is a view of a tower/beam assembly

FIG. 2 is a view of a paired tower/beam assembly with connecting crossbars

FIG. 3 is a view of a typical body side mounting on a vehicle

FIG. 4 is a view of a typical frame side mounting on a vehicle

FIG. 5 is a view of a typical truck bed mounting

### DETAILED DESCRIPTION OF THE PREFERRED EMBODIMENTS

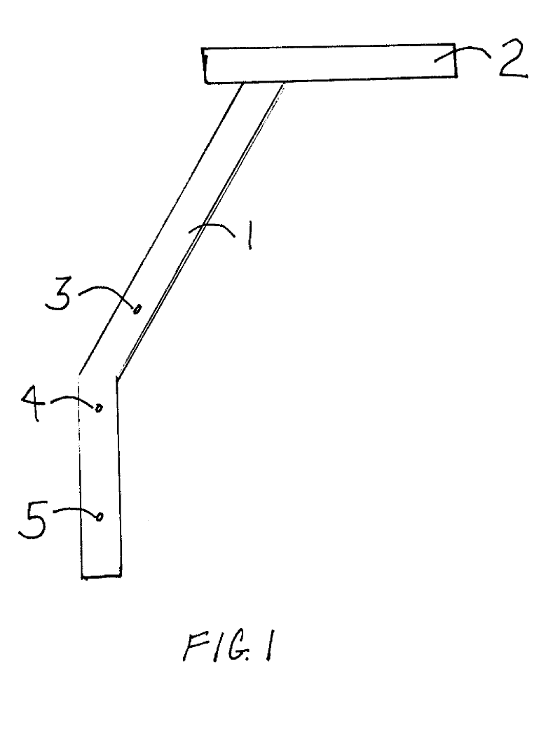

Referring now to the drawings, FIG. 1 shows a side view of a typical single tower/beam assembly. The tower is attached to the side of the vehicle in two or more points, and extends upward above the roof of the vehicle. The attached beam is cantilever mounted to the tower, and serves as an attachment point for various commonly available accessories to secure bicycles, kayaks, skis, surfboards, etc.

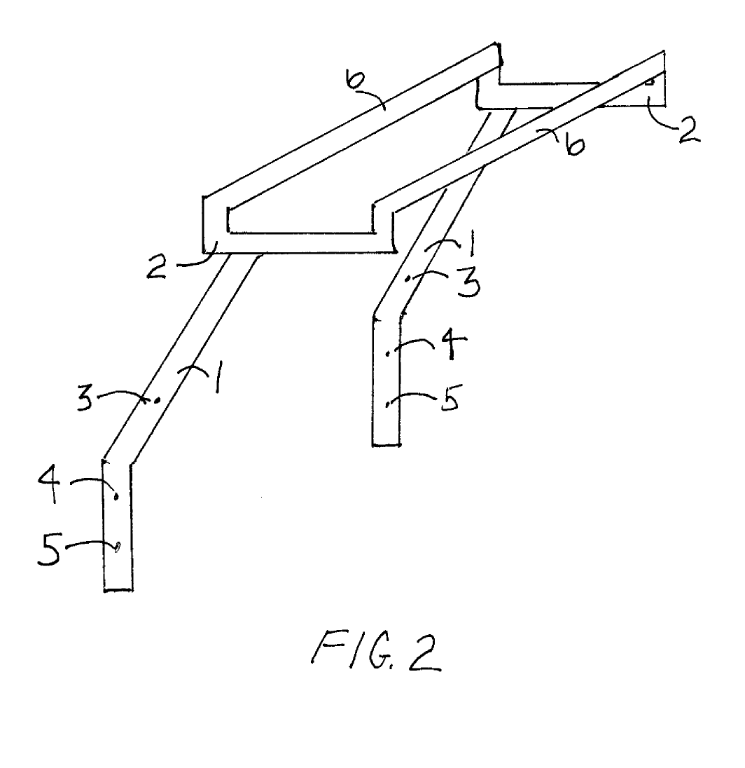

FIG. 2 shows a pair of tower/beam assemblies, connected at the top portion of the cantilevered beams with crossbars, forming a carrier frame suitable for greater carrying capacity and for a larger variety of existing accessories for mounting cargo.

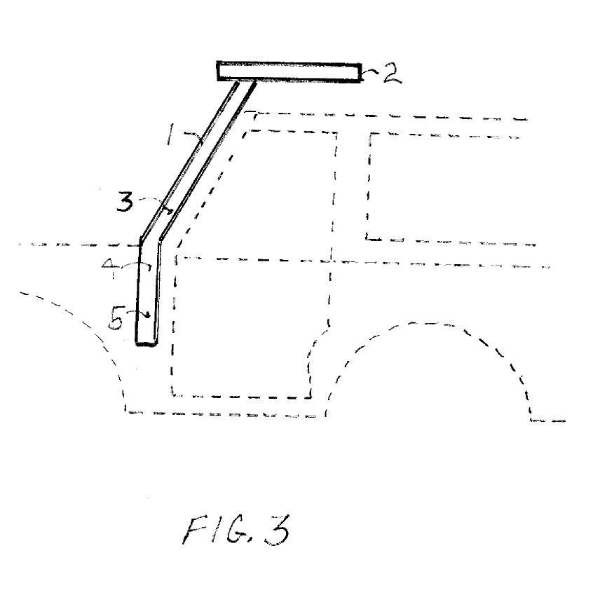

FIG. 3 shows a typical mounted tower/beam assembly on a convertible-type sport utility vehicle.

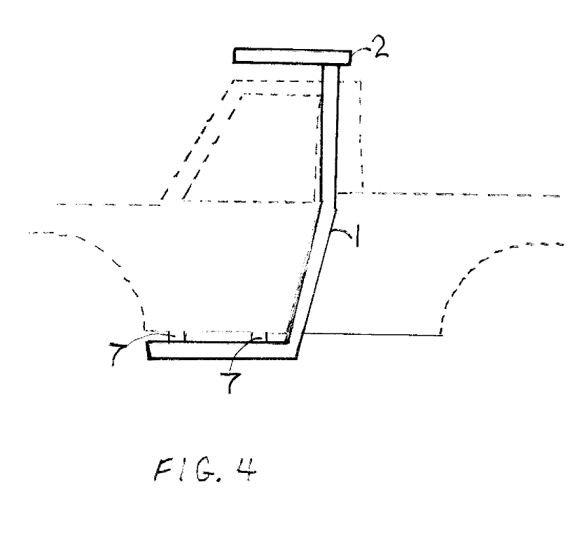

FIG. 4 shows a typical mounted tower/beam assembly on a pickup-type truck, mounted to the frame.

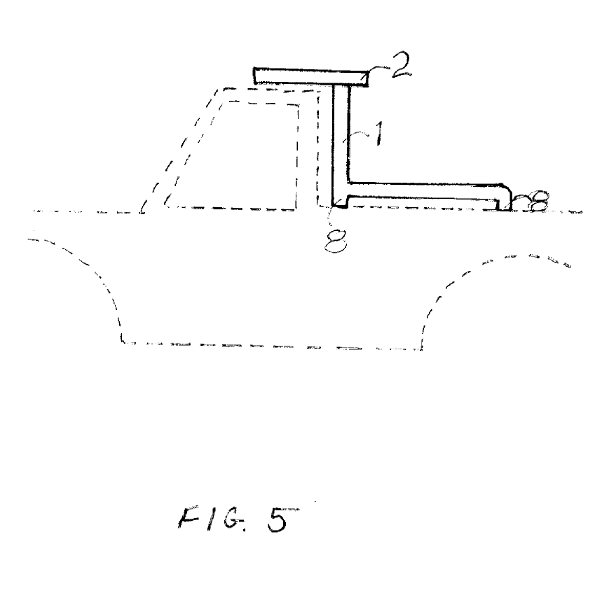

FIG. 5 shows a typical mounted tower/beam assembly on a pickup-type truck, mounted to the bed.

When a tower/beam assembly is bolted either to the body, or the side frame of a vehicle, or the bed of a pickup-type truck, it provides a rigid mount for a cantilevered beam to support objects above the roof of the vehicle. There are a variety of existing accessories available for different cargoes that attach to the beam structure. While no other vehicle attach points are required, a second tower/beam assembly may be mounted on the opposite side of the vehicle and the two tower/beam assemblies joined together with crossbars to provide a larger support frame for increased carrying capacity.

When used singly or in pairs, the tower/beam assemblies do not interfere with the operation of convertible tops, nor interfere with the installation/removal of hard tops from the vehicle.

Since certain changes may be made in the foregoing disclosure without departing from the scope of the invention herein involved, it is intended that all matter contained in the preceding description and depicted in the accompanying drawings be construed in an illustrative and not in a limiting sense.

1. A utility carrier mountable on a sport utility vehicle, a pickup-type truck, or the like, said utility carrier comprising:
a. A single tower, mounted to the side of the vehicle, the side of the frame of the vehicle, or the bed of a pickup-type truck
b. A beam mounted mounted at the top of the tower in a cantilever manner
Wherein said tower/beam assembly solely supports the cargo loaded on it, so that the weight of the carrier and the weight of the cargo is distributed to the tower assembly and the vehicle attachment points.

2. The utility carrier as claimed in claim 1, used in pairs such that:
a. A tower/beam assembly is mounted on each side of a vehicle
b. The two tower/beam assemblies are connected with crossbars at the front and rear of the cantilevered beam on each tower
Wherein said pair of tower/beam assemblies and connecting crossbars jointly support the cargo loaded on them, so that the weight of the carrier and the cargo is distributed to the tower assemblies and through them to the vehicle attachment points.
